(19) United States
(12) Patent Application Publication
(10) Pub. No.: US 2016/0222202 A1
(43) Pub. Date: Aug. 4, 2016

(54) Polyoxymethylene Compositions

(71) Applicant: E I DU PONT DE NEMOURS AND COMPANY, Wilmington, DE (US)

(72) Inventor: Makoto Kato, Utsunomiya (JP)

(21) Appl. No.: 14/613,602

(22) Filed: Feb. 4, 2015

(51) Int. Cl. C08L 33/26

(52) U.S. Cl. CPC C08L 33/26

(57) ABSTRACT

Polyoxymethylene compositions, articles comprising these compositions, and processes of making the compositions, comprising: a) at least one polyoxymethylene polymer; b) 0.02 to 1.5 wt. % of at least one amine polymer; c) 0.01 to 0.8 wt. % at least one polyamide; d) 0.02 to 0.9 wt. % of at least one nucleating agent; e) 0.01 to 0.5 wt. % of at least one formaldehyde scavenger; f) 0.02 to 0.5 wt. % of at least one antioxidant; wherein: the polyoxymethylene polymer has a melt flow rate of from about 1.5 g/10 min. to about 100 g/10 min. when measured according to ISO 1133; and an article molded from the polyoxymethylene composition exhibits formaldehyde emission of 3 ppm or less measured according to VDA 275 test method; and tensile creep to 10% strain at 80° C. and 25 MPa pressure of at least 6 hours, as measured according to ASTM D2990.

### OVERVIEW

Described herein are thermally stabilized polyoxymethylene resin compositions that, when molded, have a combined property of certain formaldehyde emissions and a certain creep to 10% strain.

Polyoxymethylene (POM, also known as polyacetal) compositions exhibit tribology, hardness, stiffness, toughness, coefficient of friction, solvent resistance, and the ability to crystallize rapidly that are particularly suitable to produce articles for demanding uses. However, during melt-processing, polyoxymethylenes can degrade and release formaldehyde. Formaldehyde evolution, measured as thermally evolved formaldehyde (TEF-T), is an indirect measure of the heat stability of POM compositions.

However, articles prepared from POM compositions can release formaldehyde over time, especially in high temperature environments. The formaldehyde evolution can be measured as evolved formaldehyde using any of a number of methods. One such method is VDA275 which measures formaldehyde emission of articles produced from POM compositions.

Effort is frequently given to methods of reducing formaldehyde emissions in POM compositions during processing and/or from articles produced from the POM compositions. In particular, such efforts include adding one or more ingredients to POM compositions to reduce formaldehyde emissions, improve creep properties, impact resistance, etc. of the resultant article. Additives known to improve one property may reduce another property, so combining additives have recognized limitations. Improving formaldehyde emission can be achieved by adding formaldehyde scavengers such as allantoin compounds to POM compositions. However, addition of allantoin to POM compounds may reduce other physical properties, such as creep, which is undesirable.

U.S. Pat. No. 5,011,890 discloses POM compositions that contain polymers having formaldehyde reactive nitrogen groups such as polyacrylamide. U.S. Pat. No. 5,106,888 discloses polyacetal compositions that contain microcrystalline cellulose (MCC) as a thermal stabilizer with polyamide. U.S. Pat. No. 6,642,289 discloses POM compositions that contain an allantoin compound and optionally a basic nitrogen-containing compound and/or an antioxidant that contributes to stability, particularly heat stability, of polyacetal resins and suppression of formaldehyde emission.

Needed are polyoxymethylene compositions that, when molded into articles, exhibit a combined property of certain formaldehyde emission and a certain creep to 10% strain.

Disclosed herein are polyoxymethylene compositions that, when molded into articles, exhibit the compound property of formaldehyde emissions of 3 ppm or less, preferably 2 ppm or less, and a creep to 10% strain of at least 6 hours. Specifically disclosed herein are polyoxymethylene compositions comprising:
a) at least one polyoxymethylene polymer;
b) about 0.02 to about 1.5 wt. % of at least one amine polymer;
c) about 0.01 to about 0.8 wt. % at least one polyamide;
d) about 0.02 to about 0.9 wt. % of at least one nucleating agent;
e) about 0.01 to about 0.5 wt. % of at least one formaldehyde scavenger;
f) about 0.02 to about 0.5 wt. % of at least one antioxidant;
g) optionally, an additional additive selected from the group consisting of waxes, ultraviolet stabilizers, colorants, lubricants, and mixtures of these;
   wherein the polyoxymethylene polymer has a melt flow rate of from about 1.5 g/10 min. to about 100 g/10 min. when measured according to ISO 1133; and
an article molded from the polyoxymethylene composition exhibits:
a formaldehyde emission of 3 ppm or less measured according to VDA275 test method; and
a tensile creep to 10% strain at 80° C. and 25 MPa pressure of at least 6 hours, as determined according to ASTM D2990.

Also disclosed herein are polyoxymethylene compositions comprising:
a) at least one polyoxymethylene polymer;
b) about 0.02 to about 1.5 wt. % of at least one amine polymer;
c) about 0.01 to about 0.8 wt. % at least one polyamide;
d) about 0.02 to about 0.9 wt. % of at least one nucleating agent;
e) about 0.01 to about 0.5 wt. % of at least one formaldehyde scavenger;
f) about 0.02 to about 0.5 wt. % of at least one antioxidant;
g) optionally, from about 0.01 to about 1.0 wt. % an additional additive selected from the group consisting of waxes, ultraviolet stabilizers, colorants, lubricants, and mixtures of these;
   wherein the polyoxymethylene polymer has a melt flow rate of from about 3 g/10 min. to about 100 g/10 min. when measured according to ISO 1133; and
an article molded from the polyoxymethylene composition exhibits:
a formaldehyde emission of 2 ppm or less measured according to VDA 275 test method; and
a tensile creep to 10% strain at 80° C. and 25 MPa pressure of at least 6 hours, as determined according to ASTM D2990.

Also disclosed herein are articles made of these compositions and processes of making the compositions and articles.

### DETAILED DESCRIPTION

### Definitions

As used herein, the terms “a”, “an” refers to one, more than one and at least one and therefore does not necessarily limit its referent noun to the singular.

As used herein, the terms “comprises,” “comprising,” “includes,” “including,” “has,” “having”, “consisting essentially of”, and “consisting of” or any other variation of these, may refer either to a non-exclusive inclusion or to an exclusive inclusion.

When these terms refer to a non-exclusive inclusion, a process, method, article, or apparatus that comprises a list of elements is not limited to the listed elements but may include other elements not expressly listed or which may be inherent. Further, unless expressly stated to the contrary, “or” refers to an inclusive, not an exclusive, or. For example, a condition A or B is satisfied by any one of the following: A is true (or present) and B is false (or not present), A is false (or not present) and B is true (or present), and both A and B are true (or present).

When these terms refer to a more exclusive inclusion, these terms limit the scope of a claim to those recited materials or steps that materially affect the novel elements of the recited invention. When these terms refer to a wholly exclusive inclusion, these terms exclude any element, step or component not expressly recited in the claim.

As used herein, the term “article” refers to an unfinished or finished item, thing, object, or an element or feature of an unfinished or finished item, thing or object. As used herein, when an article is identified as unfinished, the term “article” may refer to any item, thing, object, element, device, etc. that will be included in a finished article and/or will undergo further processing in order to become a finished article.

As used herein, when an article is identified as finished, the term “article” refers to an item, thing, object, element, device, etc. that has undergone processing to completion to thereby be suitable for a particular use/purpose.

An article may comprise one or more element(s) or subassembly(ies) that either are partially finished and awaiting further processing or assembly with other elements/subassemblies that together will comprise a finished article.

As used herein, the terms “polyoxymethylene” and “polyacetal” includes homopolymers of formaldehyde or of cyclic oligomers of formaldehyde, the terminal groups of which are end-capped by esterification or etherification, and co-polymers of formaldehyde or of cyclic oligomers of formaldehyde and other monomers that yield oxyalkylene groups with at least two adjacent carbon atoms in the main chain, the terminal groups of which co-polymers can be hydroxyl terminated or can be end-capped by esterification or etherification.

As used herein, the term “amine polymer” refers to a polymer having “formaldehyde reactive nitrogen groups” as described in U.S. Pat. No. 5,011,890, col. 7:22-42, which portion of the '890 patent is hereby incorporated herein by reference.

As used herein, the term “polyamide” refers to a polymer prepared from the condensation of one or more dicarboxylic acids and one or more diamines, and/or one or more aminocarboxylic acids, and/or ring-opening polymerization products of one or more cyclic lactams.

As used herein, the term “nucleating agent” refers to any particulate material that nucleates polyoxymethylene. The nucleating agent can be organic or inorganic and has an average particle size of 100 microns or less.

As used herein, the term “formaldehyde scavenger” refers to any organic cyclic compound having an active imino group which has a high capacity to form a methylol group by reacting with formaldehyde.

As used herein, the term “antioxidant” refers to a monocyclic hindered phenol compound, a polycyclic hindered phenol compound bonded by a hydrocarbon group or a group containing sulfur atom, and a hindered phenol compound having an ester group or amide group.

As used herein, the term “tensile creep to strain” refers generally to the time a test sample took to reach a specified percent strain under a certain load and at a certain temperature. The term “tensile creep to 10% strain at 80° C.” refers to the time for the test sample to reach 10% strain under a certain load and at 80° C. Tensile creep to strain is determined according to ASTM D2990 and informs on the long-term stability of a molded test sample under specific conditions.

As used herein, the tern “melt flow rate” or “melt index” refers to a measure of the flow of a thermoplastic polymer in the melt and is defined as the mass of polymer, in grams, flowing in ten minutes through a capillary of a specific diameter and length at a certain pressure and temperature measured according to ISO 1133. Melt flow rate is an indirect measure of the molecular weight of a polymer.

As used herein, the term “emitted formaldehyde” or “formaldehyde emission” refers to that formaldehyde which evolves from articles prepared from polyoxymethylene compositions as measured according to the VDA 275 test method and recorded as ppm formaldehyde.

As used herein, the term “VDA 275” refers to the test method for formaldehyde emission determined by the German Association of the Automotive Industry (German: Verband der Automobilindustrie e. V.).

### Ranges

Any range set forth herein includes its endpoints unless expressly stated otherwise. Setting forth an amount, concentration, or other value or parameter as a range specifically discloses all ranges formed from any pair of any upper range limit and any lower range limit, regardless of whether such pairs are separately disclosed herein. To the point, the ranges in the compositions and articles described herein are not limited to specific pairs of upper and lower limits disclosed in the description.

### Preferred Variants

The setting forth of variants in terms of materials, methods, steps, values, ranges, etc.—whether identified as preferred variants or not--of the compositions and articles described herein is specifically intended to disclose any composition and article that includes ANY combination of such materials, methods, steps, values, ranges, etc. Such combinations are specifically intended to be preferred variants of the compositions and articles described herein.

### Abbreviations

As used herein, “weight percent” is abbreviated as “wt %”.

As used herein, “polyoxymethylene” is abbreviated as “POM”.

As used herein, “Megapascals” is abbreviated as “MPa”.

As used herein, “grams per mole” is abbreviated as “g/mol”.

As used herein, “grams per minute” is abbreviated as “g/min”.

As used herein, “milliliter” is abbreviated as “ml”.

As used herein, “parts per million” is abbreviated as “ppm”.

Generally: Compositions Described Herein

The compositions described herein are polyoxymethylene compositions comprising:
a) at least one polyoxymethylene polymer;
b) about 0.02 to about 1.5 wt. % of at least one amine polymer;
c) about 0.01 to about 0.8 wt. % at least one polyamide;
d) about 0.02 to about 0.9 wt. % of at least one nucleating agent;
e) about 0.01 to about 0.5 wt. % of at least one formaldehyde scavenger;
f) about 0.02 to about 0.5 wt. % of at least one antioxidant;
g) optionally, from about 0.01 to about 1.0 wt. % an additional additive selected from the group consisting of waxes, ultraviolet stabilizers, colorants, lubricants, and mixtures of these;
   wherein the polyoxymethylene polymer has a melt flow rate of from about 1.5 g/10 min. to about 100 g/10 min. when measured according to ISO 1133; and
   wherein an article molded from the polyoxymethylene composition exhibits:
a formaldehyde emissions of 3 ppm or less measured according to VDA 275 test method; and
a tensile creep to 10% strain at 80° C. and 25 MPa pressure of at least 6 hours, as determined according to ASTM D2990.

Also disclosed herein are polyoxymethylene compositions comprising:
a) at least one polyoxymethylene polymer;
b) about 0.02 to about 1.5 wt. % of at least one amine polymer;
c) about 0.01 to about 0.8 wt. % at least one polyamide;
d) about 0.02 to about 0.9 wt. % of at least one nucleating agent;
e) about 0.01 to about 0.5 wt. % of at least one formaldehyde scavenger;
f) about 0.02 to about 0.5 wt. % of at least one antioxidant;
g) optionally, from about 0.01 to about 1.0 wt. % an additional additive selected from the group consisting of waxes, ultraviolet stabilizers, colorants, lubricants, and mixtures of these;
   wherein the polyoxymethylene polymer has a melt flow rate of from about 3 g/10 min. to about 100 g/10 min. when measured according to ISO 1133; and
   wherein an article molded from the polyoxymethylene composition exhibits:
a formaldehyde emissions of 2 ppm or less measured according to VDA 275 test method; and
a tensile creep to 10% strain at 80° C. and 25 MPa pressure of at least 6 hours, as determined according to ASTM D2990.

Any of the compositions and methods described herein includes the elements described in the previous paragraph AND may also include any combination of the following elements set forth in this paragraph. And, to avoid ambiguity, this paragraph is intended to set forth express, literal, and photographic support for any composition described herein that includes any one or any combination of the following elements in this paragraph. Specifically, the compositions described herein also may:
additionally comprise additive (g) selected from the group consisting of waxes, ultraviolet stabilizers, colorants, lubricants, and mixtures of these;
have, for component (b), an amine polymer selected from the group consisting of polyacrylamides, polyallylamines, polyaminoalkyl acrylate, polyaminoalkyl methacrylate, polyvinylalkylamine, poly-β-alanine, and mixtures of these;
have, for component (c), a polyamide selected from the group consisting of PA6, PA11, PA12, PA10, PA610, PA612, PA1010, PA66/610/6, PA66/612/6, PA66/614/6, PA610/612/6, PA610/614/6, PA612/614/6, and mixtures of these;
have, for component (d), a nucleating agent selected from the group consisting of titanium oxides, boron compounds, silica, silicates, montmorillonite, calcium carbonate, valentinite, pyrophyllite, dolomite, melamine-formaldehyde condensates, phyllosilicates, talc, sulfates, carbonates, terpolymers of trioxane, and mixtures of these;
have, for component (e), a formaldehyde scavenger selected from the group consisting of hydantoin compounds, imidazole compounds, and mixtures of these;
have, for component (f), an antioxidant which is a hindered phenol antioxidant.

### (a) Polyoxymethylene (POM) Polymer

The polyoxymethylene (also known as polyacetal) in the compositions described herein may be one or more homopolymers, copolymers, or mixtures of these. Homopolymers are prepared by polymerizing formaldehyde or formaldehyde equivalents, such as cyclic oligomers of formaldehyde.

Copolymers may contain one or more co-monomers generally used in preparing polyoxymethylene compositions, which include acetals and cyclic ethers that lead to the incorporation into the polymer chain of ether units with 2-12 sequential carbon atoms. If a copolymer is used in these compositions, the quantity of co-monomer will not be more than 20 weight percent, preferably not more than 15 weight percent, and most preferably about two weight percent. Preferable comonomers are 1,3-dioxolane, ethylene oxide, and butylene oxide, where 1,3-dioxolane is more preferred, and preferable polyoxymethylene copolymers are copolymers where the quantity of co-monomer is about 2 weight percent.

It is also preferred that the homo- and copolymers are: 1) homopolymers whose terminal hydroxy groups are end-capped by a chemical reaction to form ester or ether groups; or, 2) copolymers that are not completely end-capped, but that have some free hydroxy ends from the co-monomer unit or are terminated with ether groups. Suitable end groups for homopolymers are acetate and methoxy and preferred end groups for copolymers are hydroxy and methoxy.

The polyoxymethylene used in the compositions described herein may be branched or linear and generally have a number average molecular weight of at least 10,000, preferably 20,000-90,000. The molecular weight may be conveniently measured by gel permeation chromatography in m-cresol at 160° C. using a DuPont PSM bimodal column kit with nominal pore size of 60 and 1000 angstrom. The molecular weight may also be measured by determining the melt flow using ASTM D1238 or ISO 1133. The melt flow will be in the range of 0.1 to 100 g/10 min, preferably from 1.5 to 100 g/10 min, more preferably from 3 to 60 g/10 min, and most preferably from 3 to 40 g/10 min for injection molding purposes.

The amount of POM in these compositions ranges from about 94.8 to about 99.9, preferably from 96.00 to 99.3, more preferably from 97 to 99.3, and most preferably from 98 to 99.3 weight percent of the total weight of the composition.

### (b) Amine Polymer

Component (b) in the polyoxymethylene compositions described herein is an amine polymer selected from polyacrylamides, polyallylamines, polyacrylic hydrazide, poly-β-alanine, polymethacrylic hydrazide, polyaminoalkyl acrylate, polyaminoalkyl methacrylate, poly vinylalkylamine, and mixtures of these.

The amine polymer is preferably a polyacrylamide, which preferably has a weight-average molecular weight (M_{w}) of about 20,000 to 30,000 g/mol and preferably a weight-average molecular weight (M_{w}) of about 2,4,000 g/mol, a number-average molecular weight (Mₙ) of about of 5,000 to 10,000 g/mol and a polydispersity index of about 2.5 to 3.5, preferably about 3.1, as measured by aqueous gel permeation chromatography.

The amount of component (b) in these compositions ranges from 0.02 to 1.5, preferably from 0.05 to 1.2, more preferably from 0.10 to 1.0, and most preferably from 0.2 to 0.8 weight percent of the total weight of the composition.

### (c) Polyamide

Component (c) in the polyoxymethylene compositions described herein is a polyamide. The designation of the polyamides herein corresponds to international standard ISO 1874-1, in which the first number indicates the number of carbon atoms of the starting amine and the last number indicating the number of carbon atoms of the dicarboxylic acid. When the designation has only a single number, that number indicates the number of carbon atoms of an amino-carboxylic acid or its lactam, respectively. For example, the polyamide from hexamethylenediamine and sebacic acid is designated as polyamide 610 (PA 610); the polyamide from caprolactam is designated as PA 6. The components are separately listed by slash in order of their parts per amount and are followed by the parts per amount within brackets, e. g. copolyamide 6/66/610 (50:30:20) to characterize copolyamides.

Polyamide resins used in the manufacture of the polyoxymethylene composition are condensation products of one or more dicarboxylic acids and one or more diamines, and/or one or more aminocarboxylic acids, and/or ring-opening polymerization products of one or more cyclic lactams. The polyamide resins are selected from fully aliphatic polyamide resins, semi-aromatic polyamide resins and mixtures thereof. The term “semi-aromatic” describes polyamide resins that comprise at least some aromatic carboxylic acid monomer(s) and aliphatic diamine monomer(s), in comparison with “fully aliphatic” which describes polyamide resins comprising aliphatic carboxylic acid monomer(s) and aliphatic diamine monomer(s).

Fully aliphatic polyamide resins are formed from aliphatic and alicyclic monomers such as diamines, dicarboxylic acids, lactams, aminocarboxylic acids, and their reactive equivalents. A suitable aminocarboxylic acid includes 11-aminododecanoic acid. Suitable lactams include caprolactam and laurolactam. As used herein, the term “fully aliphatic polyamide resin” refers to copolymers derived from two or more such monomers and blends of two or more fully aliphatic polyamide resins. Linear, branched, and cyclic monomers may be used.

Carboxylic acid monomers suitable for the preparation of fully aliphatic polyamide resins include, but are not limited to, aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14). Suitable diamines include those having four or more carbon atoms, including, but not limited to tetramethylene diamine, hexamethylene diamine, octamethylene diamine, decamethylene diamine, 2-methylpentamethylene diamine, 2-ethyltetramethylene diamine, 2-methyloctamethylene diamine; trimethylhexamethylene diamine, and mixtures of any combination of these thereof. Suitable examples of fully aliphatic polyamide polymers include poly(ε-caprolactam) PA6; poly(2-methylpentamethylene hexanediamide (PAD6); poly(pentamethylene decanediamide) (PA510); poly(hexamethylene dodecanediamide) (PA612); poly(hexamethylene tridecanediamide) (PA613); PA614; poly(hexamethylene pentadecanediamide) (PA615); PA616; poly(11-aminoundecanamide) (PA11); poly(12-aminododecanamide) (PA12); PA10; PA 912; PA913; PA914; PA915; PA616; PA936; PA1010; PA1012; PA1013; PA1014; PA1210; PA1212; PA12,13; PA1214 and copolymers and blends of the same. Especially suitable examples of fully aliphatic polyamide resins include PA6, PA11, PA12, PA10; PA610; PA612; PA1010 and copolymers and blends of the same. Especially suitable examples of fully aliphatic copolyamides include PA66/610/6; PA66/612/6; PA66/614/6; PA610/612/6; PA610/614/6; PA612/614/6.

Semi-aromatic polyamide resins suitable as polyamide (c) are preferably copolymers, terpolymers, or higher polymers wherein at least a portion of the acid monomers are selected from one or more aromatic dicarboxylic acids. The one or more aromatic dicarboxylic acids can be, for example, terephthalic acid or mixtures of terephthalic acid and one or more other carboxylic acids, like isophthalic acid, substituted phthalic acid such as for example 2-methylterephthalic acid and unsubstituted or substituted isomers of naphthalenedicarboxylic acid. Preferably, the one or more aromatic dicarboxylic acids are selected from terephthalic acid, isophthalic acid and mixtures thereof. Furthermore, the one or more dicarboxylic acids can be mixed with one or more aliphatic dicarboxylic acids, like adipic acid; pimelic acid; suberic acid; azelaic acid; sebacic acid and dodecanedioic acid, to provide a semi-aromatic polyamide. Semi-aromatic polyamide resins also comprise one or more diamines that can be chosen among diamines having four or more carbon atoms, including, but not limited to tetramethylene diamine, hexamethylene diamine, octamethylene diamine, nonamethylene diamine, decamethylene diamine, 2-methylpentamethylene diamine, 2-ethyltetramethylene diamine, 2-methyloctamethylene diamine; trimethylhexamethylene diamine, bis(p-aminocyclohexyl)methane; m-xylylene diamine; p-xylylene diamine, and mixtures of any combination of these.

The polyamide of component (c) may be an aliphatic polyamide, a semi-aromatic polyamide, or a mixture of these. Component (c) preferably includes homopolyamides and copolyamides, e.g., polyamide 12, polyamide 612 and polyamide 66/610/6, and substituted polyamides having a methylol group or other groups having a hydroxyl group.

An especially preferred polyamide for component (c) is PA66/610/6 terpolymer having aliphatic repeat units selected from the group consisting of hexamethylene hexanediamide, hexamethylene decanediamide and ε-caprolactam.

The amount of component (c) in these compositions ranges from 0.01 to 0.8, preferably from 0.01 to 0.6, more preferably from 0.02 to 0.6, and most preferably from 0.02 to 0.5, percent of the total weight of the composition.

### (d) Nucleating Agent

Component (d) in the polyoxymethylene compositions described herein can be any particulate material that nucleates polyoxymethylene. Preferably, the nucleating agent is selected from titanium oxides, boron compounds, such as boron nitride, silica, silicates, montmorillonite, calcium carbonate, valentinite, pyrophyllite, dolomite, organic or inorganic pigments, melamine-formaldehyde condensates, phyllosilicates, talc, powdered sulfates or carbonates, terpolymers of trioxane, and ethylene oxide and butanediol diglycidyl ethers. Preferred nucleating agents include talc, boron nitride and terpolymers of trioxane.

The nucleating agent may have an average particle size of 100 microns or less, preferably 10 microns or less, more preferably 5 microns or less, and most preferably 1 micron or less.

The amount of nucleating agent (d) in the polyoxymethylene compositions ranges from 0.01 to 0.9, preferably from 0.01 to 0.7, more preferably from 0.02 to 0.5, and most preferably from 0.02 to 0.4 weight percent of the total weight of the composition.

### (e) Formaldehyde Scavenger

Component (e) in the polyoxymethylene compositions described herein is a formaldehyde scavenger. One class of formaldehyde scavengers are organic cyclic compounds having an active imino group. Examples of organic cyclic compounds having an active imino group include hydantoins and imidazole compounds such as hydantoin, dimethylhydantoin (e.g., 5,5-dimethylhydantoin) and allantoin.

The amount of formaldehyde scavenger (e) in the polyoxymethylene compositions ranges from 0.01 to 0.5, preferably from 0.03 to 0.4, more preferably from 0.05 to 0.4, and most preferably from 0.1 to 0.3 weight percent of the total weight of the composition.

### (f) Antioxidants)

Component (f) in the polyoxymethylene compositions described herein is an antioxidant. The antioxidant is preferably a hindered phenol-based antioxidant. The hindered phenol-based antioxidant includes a monocyclic hindered phenol compound, a polycyclic hindered phenol compound bonded by a hydrocarbon group or a group containing sulfur atom, and a hindered phenol compound having ester group or amide group. The above compounds can be exemplified as follows: 2,6-di-t-butyl-p-cresol; 2,2′-methylenebis(4-methyl-6-t-butylphenol); 4,4′-methylenebis(2,6-di-t-butylphenol); 1,1,3-tris(2-methyl-4-hydroxy-5-t-butylphenyl)butane; 4,4′butylidenebis(3-methyl-6-t-butylphenol); 1,3-5-trimethyl-2-4,6-tris(3,5-di-t-butyl-4-hydroxybenzyl)benzene; 4,4′-thiobis(3-methyl-6-t-butylphenol); n-octadecyl-3-(4′-hydroxy-3′,5′-di-t-butylphenyl)propionate; n-octadecyl-2-(4′-hydroxy-3′,5′-di-t-butylphenyl)propionate; 1,6-hexanediol-bis[3-(3,5-di-t-butyl-4-hydroxphenyl)propionate]; ethylenebis(oxyethylene)bis-[3-(5-tert-butyl-4-hydroxy-m-tryl)propionate]; pentaerythritol tetrakis[3-(3,5-di-t-butyl-4-hydroxyphenyl)propionate]; 3,9-bis[2-{3-(3-t-butyl-4-hydroxy-5-methylphenyl)-propionyloxy}-1,1-dimethylethyl]-2,4,8,10-tetraoxaspiro-[5,5]undecane; 2-t-butyl-6-(3′-t-butyl-5′-methyl-2′-hydroxybenzyl)-4-methylphenylacrylate; 2-[1-(2-hydroxy-3,5-di-t-pentylphenyl)ethyl]-4,6-di-t-pentylphenylacrylate; di-n-octadecyl-3,5-di-t-butyl-4-hydroxybenzylphosphonate; N,N′-hexamethylenebis-(3,5-di-t-butyl-4-hydroxy-dihydro-cinnamamide; N,N′-ethylenebis[3-(3,5-di-t-butyl-4-hydroxyphenyl)-propionamide]; N,N′-tetramethylenebis[3-(3,5-di-t-butyl-4-hydroxyphenyl)-propionamide]; N,N′-hexamethylenebis-[3-(3,5-di-t-butyl-4-hydroxyphenyl)-propionamide]; N,N′-ethylenebis[3-(3-t-butyl-5-methyl-4-hydroxyphenyl)propionamide]; N,N′-hexamethylenebis-[3-(3-t-butyl-5-methyl-4-hydroxyphenyl)propionamide]; N,N′-bis[3-(3,5-di-t-butyl-4-hydroxyphenyl)propyonyl]hydrazine; N,N′-bis[3-(3-t-butyl-5-methyl-4-hydroxphenyl)propyonyl]hydrazine; 1,3,5-tris(3,5-di-t-butyl-4-hydroxybenzyl)isocyanurate; 1,3,5-tris(4-t-butyl-3-hydroxy-2,6-dimethylbenzyl)-isocyanurate, and similar compounds.

Preferred examples of hindered phenol antioxidant compounds include pentaerythrityl tetrakis[3-(3,5-di-tert-butyl-4-hydroxyphenyl)propionate] (Irganox 1010), triethylene glycol bis[3-(3-tert-butyl-4-hydroxy-5-methylphenyl)propionate] (Irganox 245), 3,3′-bis[3-(3,5-di-tert-butyl-4-hydroxyphenyl)propionohydrazide] (Irganox MD 1024), hexamethylene glycol bis[3-(3,5-di-tert-butyl-4-hydroxyphenyl)propionate] (Irganox 259), N,N′-(Hexane-1,6-diyl)bis(3,5-di-tert-butyl-4-hydroxybenzenepropanamide) (Irganox 1098) and 3,5-di-tert-butyl-4-hydroxytoluene (Lowinox BHT). Preferred hindered phenol antioxidants are Irganox 1010, Irganox 245, Irganox 1098 or combinations of these.

The amount of antioxidant (f) in the polyoxymethylene compositions ranges from 0.02 to 0.5, preferably from 0.05 to 0.4, more preferably from 0.1 to 0.4, and most preferably from 0.1 to 0.3 weight percent of the total weight of the polyoxymethylene composition.

### (g) Additives(s)

The compositions described herein may include additives so long as no additive materially affects the basic and novel characteristics of the compositions recited in the claims, and specifically the formaldehyde emissions (measured according to VDA275) and tensile creep value to 10% strain at 80° C.

Additives include, but not limited to, lubricants, UV stabilizers, and colorants. Suitable lubricant additives include silicone lubricants such as dimethylpolysiloxanes and their derivatives; oleic acid amides; alkyl acid amides. Other suitable additives include non-ionic surfactant lubricants; hydrocarbon waxes; chlorohydrocarbons; fluorocarbons; oxy-fatty acids; esters such as lower alcohol esters of fatty acids; polyvalent alcohols such as polyglycols and polyglycerols; and metal salts of fatty acids, such as lauric acid and stearic acid. Suitable ultraviolet light stabilizers include benzotriazoles, benzophenones, aromatic benzoates, cyano acrylates, and oxalic acid anilides.

### Properties of Molded Polyoxymethylene Compositions Described Herein

Polyoxymethylene compositions are used in the manufacture of molded articles, such as gears, safety restraint parts, especially for use in automotive applications. Articles prepared from polyoxymethylene compositions can release formaldehyde over time, especially in high temperature environments. Because formaldehyde is labeled as a carcinogen in many countries, such formaldehyde emissions are undesirable. Efforts to reduce formaldehyde emissions include adding one or more ingredients to polyoxymethylene compositions to reduce formaldehyde emissions. However, additives known to improve one property, such as formaldehyde emissions, may reduce another property such as creep, so finding a balance of physical properties has recognized limitations.

The polyoxymethylene compositions described herein exhibit a surprising combination of properties which improve formaldehyde emissions while simultaneously providing good creep properties compared to polyoxymethylene compositions not comprising the recited components. The polyoxymethylene compositions are not only sensitive to the addition of non-recited components, but are also sensitive to the concentration of the existing components. If any of components (b) to (f) are absent or are outside the recited concentration ranges, the polyoxymethylene compositions do not exhibit the desired combination of formaldehyde emissions and creep properties.

The polyoxymethylene compositions described herein achieve the recited combination of properties when components (b)to (f) are present in a very narrow concentration range. That is, if a POM composition includes all recited ingredients except polyamide (c), it may exhibit creep in the recited range herein, but also exhibits an undesirable increase in formaldehyde emission compared to POM compositions described and recited herein. Likewise, if a POM composition lacks only amine polymer (b) of the recited elements, it may exhibit an improved creep over the same POM composition lacking component (c) and will also exhibit higher formaldehyde emission. Similarly, if a POM composition lacks only nucleating agent (d), its formaldehyde emission may be in the recited range, but at the expense of creep properties.

The combined property of these POM compositions depends not only on the presence of recited elements (b) to (f), but also upon the specific ranges of weight percents of these elements. Thus, if an element is present in an amount outside the recited range, the POM composition exhibits a combined property of formaldehyde and creep that is outside the desired ranges. For example, if nucleating agent (d) is present at a concentration of 1.0 weight percent, the creep is within the recited range but the formaldehyde emission is not.

It is only when the polyoxymethylene composition comprises components (b) to (f) in the recited ranges does it exhibit the combined balance of creep and formaldehyde emission.

The POM compositions described herein may include additional additives so long as no additive materially affects the basic and novel characteristics of the compositions recited in the claims, specifically a formaldehyde emission of 2 ppm or less measured according to VDA275 test method and a tensile creep to 10% strain at 80° C. and 25 MPa pressure of at least 6 hours, as determined according to ASTM D2990.

### Methods of Making the Compositions Described Herein

The polyoxymethylene compositions described herein may be made by melt-blending the components using any known methods. The component materials may be mixed to homogeneity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until homogeneous. When adding the components in a stepwise fashion, part any component and any other component may be first added and melt-mixed with the remaining components and further melt-mixed until a well-mixed composition is obtained. The melt-mixing can result in pellets, which can be extruded or molded into articles.

### Articles Comprising the Compositions Described Herein

The compositions described herein may be molded into articles using any suitable melt-processing technique known in the art, such as injection molding, extrusion molding, blow molding, and injection blow molding. Injection blow molding and injection molding are more preferred with injection molding most preferred. In addition, these compositions may be formed into films and sheets by extrusion to result in either cast and/or blown films. Such sheets may be further thermoformed into articles and structures that may be oriented from the melt or at a later stage in processing.

These compositions may also be used to form fibers and filaments that may be oriented from the melt or at a later stage in processing. Articles comprising these compositions include, without limitation, gears, toys, cigarette lighter bodies, writing pen bodies, conveyor belt parts, safety restraint parts, car interior parts, etc.

### EXAMPLES

The exemplary compositions identified by “E” in the tables below are intended only to further illuminate and not to limit the scope of compositions, methods, and articles described and recited herein. Comparative examples are identified in the tables below by “C”.

### Materials

In the compositions listed in the tables below, the following materials were used:
POM-A: Delrin® 100 acetal homopolymer having a melt flow index (190° C.; 2.16 kg. ISO 1133) of 2 g/10 min., available from E.I. DuPont de Nemours and Company, Wilmington, Del., USA [DuPont].
POM-B: Delrin® 500 acetal homopolymer having a melt flow index (190° C.; 2.16 kg. ISO 1133) of 12 g/10 min., available from E.I. DuPont de Nemours and Company, Wilmington, Del., USA [DuPont].
Amine polymer: a polyacrylamide thermal stabilizer available as MAP 1070, a 20 weight percent polyethylene glycol coated polyacrylamide.
Polyamide: PA 66/610/6 polyamide terpolymer (33/23/43 mol %) is a thermal stabilizer with melting point of 150-160° C. and is ground prior to compounding to pass a 20 MESH screen.
Nucleating Agent: Ultratalc® 60 g which is an ultrafine ground talc having a mean particle size of less than 0.9 microns and is available from Specialty Minerals, Inc.
FS-1: allantoin, formaldehyde scavenger, available from International Specialty Products (ISP).
AO-1: a hindered phenolic antioxidant: Triethylene glycol bis(3-tert-butyl-4-hydroxy-5-methylphenyl)propionate available as Irganox 245 from BASF.
AO-2: a hindered phenolic antioxidant: N-N′-hexane-1,6-diylbis(3-(3,5-di-tert-butyl-4-hydroxyphenylpropionamide)) available as Irganox 1098 from BASF.
Additive A: An ethylene vinyl alcohol copolymer available as Soranol™ AP from Nippon Gohsei.
Additive B: Ethylene bis-stearamide wax available as Kaowax EB-FF from Kao Pte Ltd.
Mold release agent: Acrawax C (N,N′ Ethylenebisstearamide), available from Lonza Chemicals.

### Methods

In the compositions listed in the tables below, the following methods were used:

### Melt Flow Rate

Melt Flow Index or Melt Flow Rate was determined using ISO 1133 and reported as grams/10 minute (190° C.; 2.16 kg.).

### Tensile Creep Test for Determining Creep to 10% Strain

Tensile creep, that is, in these examples, the time to 10% strain at 80° C., was determined according to ASTM D2990. This tensile creep test determines the deformation a polymer or polymer composition undergoes when stress is applied to a test specimen at a given temperature for a time period which results in a target strain.

### Formaldehyde Emissions

Formaldehyde emissions or thermally emitted formaldehyde from articles formed from the polyoxymethylene compositions described herein are determined according to VDA 275 test method, which has been tailored to determine formaldehyde emission of components in the interior of an automotive vehicle.

### Preparation of Test Articles

All compounding was carried out on a 40 mm twin screw extruder at a temperature of about 200° C. and a screw speed of about 180 rpm. All materials were fed into the rear of the extruder. The resulting extrudates were quenched in a water bath and pelletized. The pellets were subsequently oven dried and injection molded at 80° C. mold temperature into test specimens as disclosed in VDA275.

For creep measurements, 4 mm ISO test bars were used. For formaldehyde emissions testing using the VDA275 test procedure, 40 mm×100 mm×2 mm molded plates were used.

Formaldehyde emissions may be affected by the melt temperature of the polymer in the extruder during testing. As the melt temperature of the polymer is increased, the formaldehyde emissions may also increase. Therefore, during VDA275 formaldehyde emissions testing, it is important to maintain the melt temperature of the polymer during the extrusion process t about 210° C. or less, preferably about 200° C. for the polyoxymethylene compositions being tested.

### Discussion of Results

TABLE 1

| | Composition | | | | | | |
|---|---|---|---|---|---|---|---|
| | C1 | C2 | E1 | C3 | E2 | E3 | E4 |
| POM-B | Remainder to 100% | | | | | | |
| Amine polymer (b) | 0.475 | 0.475 | 0.625 | 0.625 | 0.625 | 0.625 | 0.625 |
| Polyamide (c) | | | 0.050 | 0.050 | 0.050 | 0.050 | 0.050 |
| Nucleating Agent (d) | 0.100 | | 0.150 | | 0.150 | 0.100 | 0.050 |
| FS-1 (e) | | 0.100 | 0.100 | 0.100 | 0.100 | 0.100 | 0.100 |
| AO-1 (f) | 0.070 | 0.150 | 0.150 | 0.150 | 0.150 | 0.150 | 0.150 |
| AO-2 (f) | 0.025 | 0.050 | 0.050 | 0.050 | 0.050 | 0.050 | 0.050 |
| Additive A (g) | 0.075 | 0.050 | | | | | |
| Additive B (g) | 0.250 | 0.150 | | 0.150 | 0.150 | | |
| Physical Properties | | | | | | | |
| VDA 275 (ppm) | 5.7 | 2.4 | 1.4 | 1.8 | 1.5 | 1.3 | 1.2 |
| Creep 10% strain (h) | 12.1 | 8.6 | 11.2 | 4.9 | 10.7 | 10.0 | 9.3 |
| Creep 36% strain (h) | 24.5 | 18.8 | 22.2 | 10.8 | 21.5 | 20.5 | 18.9 |

E1 and E3-E4 in Table 1 show the effect on creep and formaldehyde emission of varying low concentrations of nucleating agent, that is, from 0.15 weight percent to 0.05 weight percent. E1 and E3-E4 show that, as the concentration of nucleating agent went down, creep undesirably also went down as formaldehyde emission also decreased, which was desirable. C3, which was the same composition as E1 and E3-E4, except for the absence of a nucleating agent, demonstrates the lack of nucleating agent as decreased creep to 10% strain to below 6 hours. E2 shows that the addition of small amounts of additives did not adversely affect creep or formaldehyde emission.

C1 and C2 show that when a polyoxymethylene composition lacked one or more of recited components (b) to (f) the creep and/or the formaldehyde emission was (were) outside the recited range. C1 lacked both polyamide (c) and formaldehyde scavenger (e) and exhibited formaldehyde emission above the recited range but not the recited creep. C2 lacked both polyamide (c) and nucleating agent (d) and exhibited formaldehyde emission above the recited range but not the recited creep.

TABLE 2

| | Composition | | | | | |
|---|---|---|---|---|---|---|
| | C4 | E5* | C5 | E6 | E7 | E8 |
| POM-A (a) | | Remainder | | | | |
| | | to 100% | | | | |
| POM-B (a) | Remainder | | Remainder to 100% | | | |
| | to 100% | | | | | |
| Amine polymer (b) | 0.625 | 0.625 | | 1.11 | 0.310 | 0.050 |
| Polyamide (c) | | 0.050 | 0.050 | 0.090 | 0.025 | 0.625 |
| Nucleating Agent (d) | 0.150 | 0.150 | 0.150 | 0.150 | 0.150 | 0.150 |
| FS-1 (e) | 0.100 | 0.100 | 0.100 | 0.100 | 0.100 | 0.100 |
| AO-1 (f) | 0.150 | 0.150 | 0.150 | 0.150 | 0.150 | 0.150 |
| AO-2 (f) | 0.050 | 0.050 | 0.050 | 0.050 | 0.050 | 0.050 |
| Additive B (g) | 0.150 | | | | | |
| Physical Properties | | | | | | |
| VDA 275 | 2.4 | 3.0 | 2.7 | 1.6 | 2.0 | 1.7 |
| Creep 10% strain | 8.1 | 9.8 | 12.2 | 7.6 | 11.4 | 8.8 |
| Creep 36% strain | break | 25.9 | break | 15.4 | break | 17.5 |

E6 to E8 in Table 2 show that varying the concentrations of amine polymer (b) and polyamide (c) within the recited ranges achieved the recited creep and formaldehyde emission. C4 and C5 show that, when the polyoxymethylene composition lacked one or more of components (b) to (f, the creep and/or the formaldehyde emission was (were)outside the recited range.

The polyoxymethylene in E5 was a high molecular weight polyoxymethylene having a melt flow rate of less than 6 g/10 min. Example E5 shows that the formaldehyde emissions for high molecular weight polyoxymethylenes was less than or equal to 3 ppm when the composition included components (b) to (f) in the recited concentration ranges and suggested that maintaining low formaldehyde emission in high molecular weight polyoxymethylene compositions was more difficult than for lower molecular weight polyoxymethylenes.

TABLE 3

| | | | | |
|---|---|---|---|---|
| Composition | E9 | E10 | C6 | C7 |

| | |
|---|---|
| POM B (a) | Remainder to 100% |

| | | | | |
|---|---|---|---|---|
| Amine polymer (b) | 0.250 | 0.625 | 0.625 | 0.625 |
| Polyamide (c) | 0.425 | 0.050 | 0.050 | 0.050 |
| Nucleating Agent (d) | 0.150 | 0.010 | 1.000 | 0.150 |
| FS-1 (e) | 0.100 | 0.100 | 0.100 | |
| AO-1 (f) | 0.150 | 0.150 | 0.150 | 0.150 |
| AO-2 (f) | 0.050 | 0.050 | 0.050 | 0.050 |
| Physical Properties | | | | |
| VDA 275 | 1.9 | 1.9 | 4.5 | 3.6 |
| Creep 10% strain | 8.7 | 7.0 | 12.0 | 10.1 |
| Creep 36% strain | break | 14.8 | break | 19.1 |

E9 and E10 in Table 3 show that varying the concentration of amine polymer (b), polyamide (c), and nucleating agent (e) within the recited concentration range imparted to the polyoxymethylene compositions a creep to 10% strain of at least 6 hours and a formaldehyde emission value of 2 ppm or less as measured by the VDA 275 test method. C6 shows that when the nucleating agent (e) was present in the polyoxymethylene composition at a concentration above 0.9 weight percent, the resulting composition had a formaldehyde emission value above 2 ppm.

The results in Tables 1 to 3 clearly show that it is only when components (a) to (f) are present in the polyoxymethylene composition in the recited concentrations does the resulting polyoxymethylene composition exhibit a creep to 10% strain of at least 6 hours and a formaldehyde emission value of 3 ppm or less as measured by the VDA 275 test method.

What is claimed is:

1. A polyoxymethylene composition comprising:
a) at least one polyoxymethylene polymer;
b) 0.02 to 1.5 wt. % of at least one amine polymer;
c) 0.01 to 0.8 wt. % at least one polyamide;
d) 0.02 to 0.9 wt. % of at least one nucleating agent;
e) 0.01 to 0.5 wt. % of at least one formaldehyde scavenger;
f) 0.02 to 0.5 wt. % of at least one antioxidant;
g) optionally, from 0.01 to 1.0 wt. % an additional additive selected from the group consisting of waxes, ultraviolet stabilizers, colorants, lubricants, and mixtures of these;
wherein:
the polyoxymethylene polymer has a melt flow rate of from about 1.5 g/10 min. to about 100 g/10 min. when measured according to ISO 1133; and
an article molded from the polyoxymethylene composition exhibits:
formaldehyde emission of 3 ppm or less measured according to VDA 275 test method; and
tensile creep to 10% strain at 80° C. and 25 MPa pressure of at least 6 hours, as measured according to ASTM D2990.

2. The polyoxymethylene composition of claim 1, wherein the amine polymer is selected from the group consisting of polyacrylamides, polyallylamines, polyaminoalkyl acrylate, polyaminoalkyl methacrylate, polyvinylalkylamine, poly-β-alanine, and mixtures of these.

3. The polyoxymethylene composition of claim 1, wherein the polyamide is selected from the group consisting of PA6, PA11, PA12, PA10, PA610, PA612, PA1010, PA66/610/6, PA66/612/6, PA66/614/6, PA610/612/6, PA610/614/6, PA612/614/6, and mixtures of these.

4. The polyoxymethylene composition of claim 1, wherein the nucleating agent is selected from the group consisting of titanium oxides, boron compounds, silica, silicates, montmorillonite, calcium carbonate, valentinite, pyrophyllite, dolomite, melamine-formaldehyde condensates, phyllosilicates, talc, sulfates, carbonates, terpolymers of trioxane, and mixtures of these.

5. The polyoxymethylene composition of claim 1, wherein the formaldehyde scavenger is selected from the group consisting of hydantoin compounds, imidazole compounds, and mixtures of these.

6. The polyoxymethylene composition of claim 1, wherein the antioxidant is a hindered phenol antioxidant.

7. The polyoxymethylene composition of claim 1, wherein:
the polyoxymethylene polymer has a melt flow rate of from about 3 g/10 min. to about 100 g/10 min. when measured according to ISO 1133; and
an article molded from the polyoxymethylene composition exhibits:
a formaldehyde emissions of 2 ppm or less measured according to VDA 275 test method; and
a tensile creep to 10% strain at 80° C. and 25 MPa pressure of at least 6 hours, as determined according to ASTM D2990.

8. The polyoxymethylene composition of claim 7, wherein the amine polymer is selected from the group consisting of polyacrylamides, polyallylamines, polyaminoalkyl acrylate, polyaminoalkyl methacrylate, polyvinylalkylamine, poly-β-alanine, and mixtures of these.

9. The polyoxymethylene composition of claim 7 wherein the polyamide is selected from the group consisting of PA6, PA11, PA12, PA10, PA610, PA612, PA1010, PA66/610/6, PA66/612/6, PA66/614/6, PA610/612/6, PA610/614/6, PA612/614/6, and mixtures of these.

10. The polyoxymethylene composition of claim 7, wherein the nucleating agent is selected from the group consisting of titanium oxides, boron compounds, silica, silicates, montmorillonite, calcium carbonate, valentinite, pyrophyllite, dolomite, melamine-formaldehyde condensates, phyllosilicates, talc, sulfates, carbonates, terpolymers of trioxane, and mixtures of these.

11. The polyoxymethylene composition of claim 7, wherein the formaldehyde scavenger is selected from the group consisting of hydantoin compounds, imidazole compounds, and mixtures of these.

12. The polyoxymethylene composition of claim 7, wherein the antioxidant is a hindered phenol antioxidant.

13. A process of making a polyoxymethylene composition comprising the step of mixing:
a) at least one polyoxymethylene polymer;
b) 0.02 to 1.5 wt. % of at least one amine polymer;
c) a 0.01 to 0.8 wt. % at least one polyamide;
d) 0.02 to 0.9 wt. % of at least one nucleating agent;
e) 0.01 to 0.5 wt. % of at least one formaldehyde scavenger;
f) 0.02 to 0.5 wt. % of at least one antioxidant;
g) optionally, from 0.01 to 1.0 wt. % an additional additive selected from the group consisting of waxes, ultraviolet stabilizers, colorants, lubricants, and mixtures of these;
to prepare a polyoxymethylene composition,
wherein:
the polyoxymethylene polymer has a melt flow rate of from about 1.5 g/10 min. to about 100 g/10 min. when measured according to ISO 1133; and
an article molded from the polyoxymethylene composition exhibits:
formaldehyde emission of 3 ppm or less measured according to VDA 275 test method; and
tensile creep to 10% strain at 80° C. and 25 MPa pressure of at least 6 hours, as measured according to ASTM D2990.

14. The process of claim 13, wherein: the polyoxymethylene polymer has a melt flow rate of from about 3 g/10 min. to about 100 g/10 min. when measured according to ISO 1133; and an article molded from the polyoxymethylene composition exhibits:
a formaldehyde emissions of 2 ppm or less measured according to VDA 275 test method; and
a tensile creep to 10% strain at 80° C. and 25 MPa pressure of at least 6 hours, as determined according to ASTM D2990.

15. The process of claim 14, wherein the amine polymer is selected from the group consisting of polyacrylamides, polyallylamines, polyaminoalkyl acrylate, polyaminoalkyl methacrylate, polyvinylalkylamine, poly-β-alanine, and mixtures of these.

16. The process of claim 14, wherein the polyamide is selected from the group consisting of PA6, PA11, PA12, PA10, PA610, PA612, PA1010, PA66/610/6, PA66/612/6, PA66/614/6, PA610/612/6, PA610/614/6, PA612/614/6, and mixtures of these.

17. The process of claim 14, wherein the nucleating agent is selected from the group consisting of titanium oxides, boron compounds, silica, silicates, montmorillonite, calcium carbonate, valentinite, pyrophyllite, dolomite, melamine-formaldehyde condensates, phyllosilicates, talc, sulfates, carbonates, terpolymers of trioxane, and mixtures of these.

18. The process of claim 14, wherein the formaldehyde scavenger is selected from the group consisting of hydantoin compounds, imidazole compounds, and mixtures of these.

19. The process of claim 14, wherein the antioxidant is a hindered phenol antioxidant.

20. An article comprising a polyoxymethylene composition comprising:
a) at least one polyoxymethylene polymer;
b) 0.02 to 1.5 wt. % of at least one amine polymer;
c) 0.01 to 0.8 wt. % at least one polyamide;
d) 0.02 to 0.9 wt. % of at least one nucleating agent;
e) 0.01 to 0.5 wt. % of at least one formaldehyde scavenger;
f) 0.02 to 0.5 wt. % of at least one antioxidant;
g) optionally, from 0.01 to 1.0 wt. % an additional additive selected from the group consisting of waxes, ultraviolet stabilizers, colorants, lubricants, and mixtures of these;
wherein:
the polyoxymethylene polymer has a melt flow rate of from about 1.5 g/10 min. to about 100 g10/min. when measured according to ISO 1133; and
the article, when molded from the polyoxymethylene composition, exhibits:
formaldehyde emission of 3 ppm or less measured according to VDA 275 test method; and
tensile creep to 10% strain at 80° C. and 25 MPa pressure of at least 6 hours, as measured according to ASTM D2990.
